(19) United States
(12) Patent Application Publication
(10) Pub. No.: US 2018/0134947 A1
(43) Pub. Date: May 17, 2018

(54) METHODS FOR TREATING HIGH TEMPERATURE SUBTERRANEAN FORMATIONS

(71) Applicant: SCHLUMBERGER TECHNOLOGY CORPORATION, Sugar Land, TX (US)

(72) Inventors: Vladimir Alexandrovich PLYASHKEVICH, Novosibirsk (RU); Irina Alexandrovna LOMOVSKAYA, Novosibirsk (RU); Anastasia Evgenyevna SHALAGINA, Novosibirsk (RU)

(21) Appl. No.: 15/564,078

(22) PCT Filed: Apr. 3, 2015
(86) PCT No.: PCT/RU2015/000211

§ 371 Date: Oct. 3, 2017

(51) Int. Cl. C09K 8/72; C09K 8/70; C09K 8/80; C09K 8/92; E21B 43/267

(52) U.S. Cl. CPC C09K 8/725; C09K 8/70; C09K 2208/08; C09K 8/92; E21B 43/267; C09K 8/80

(57) ABSTRACT

Methods are described for treating a subterranean formation penetrated by a wellbore. The methods include injecting a treatment fluid into the wellbore. The treatment fluid has a pH in a range of from about 4.0 to about 9.0, and includes a carrier fluid, a proppant, and a degradable material which can improve proppant carrier properties of the treatment fluid. The degradable material may include stereocomplex polylactic acid, or stereocomplex polylactic acid stabilized by a carbodiimide compound. The degradable material is hydrolytically stable for at least 30 minutes at a temperature of from about 120° C. to about 200° C., or from about 120° C. to about 180° C.

### BACKGROUND

Drilling techniques are used to recover hydrocarbons (oil, condensate, and gas) from reservoirs in subterranean formations. However, the flow of hydrocarbons within the subterranean formation is often undesirably low for reasons such as inherently low permeability of the reservoirs, or damage to the formation caused by drilling and completion of the wellbore. To improve the flow of hydrocarbons from the reservoir to the wellbore, the subterranean formation may be “stimulated.” Stimulation techniques include hydraulic fracturing, chemical stimulation (e.g., acidizing), or a combination of the two (called “acid fracturing” or “fracture acidizing”).

In hydraulic fracturing and acid fracturing, a first fluid (a “pad”) is injected into the wellbore (the drill hole) and then into the subterranean formation at a pressure high enough to fracture the formation. A fracture is thus formed and propagates into the formation, increasing the surface area through which the hydrocarbons can flow.

If the injection pressure is reduced, the fracture will close. Thus, in order to retain permeability of the formation after fracture, a second fluid (a “treatment fluid”) is injected into the wellbore and contains both a carrier fluid and a “proppant.” When the injection pressure is reduced after injection of the treatment fluid, the fracture closes on the proppant and thus is held partway open, allowing the hydrocarbons to flow from the reservoir to the wellbore and ultimately to the surface for recovery.

To ensure that the proppant is adequately distributed in the carrier fluid and deposited throughout the extent of the fracture, a viscosifier is often added to the carrier fluid to ensure that the carrier fluid is viscous enough to transport the proppant. Without the addition of the viscosifier, the proppant will prematurely settle in the formation. However, the viscosifier (e.g., a polymer) may be deposited together with the proppant in the fracture once the injection pressure is reduced, decreasing the porosity of the proppant pack and inhibiting the flow of hydrocarbons.

The settling of the viscosifier may be mitigated by introducing a treatment fluid containing proppant and viscosifier in dilute amounts (sometimes called “slickwater”). To ensure that the less viscous fracture fluid adequately fractures the subterranean formation, however, the treatment fluid is pumped at a higher flow rate. This process is more expensive, and the proppant may be insufficiently distributed throughout the formation.

A degradable material may be used as a viscosifier. In this case, the degradable material degrades in situ (downhole), leaving behind a porous proppant pack. However, if the degradable material degrades too quickly, it will not effectively distribute the proppant during injection into the wellbore.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

A method is provided for treating a subterranean formation penetrated by a wellbore. The method includes injecting a treatment fluid into the wellbore. The treatment fluid has a pH in a range of from about 4.0 to about 9.0, and includes a carrier fluid, a proppant, and a degradable material. The degradable material includes stereocomplex polylactic acid, and is hydrolytically stable for at least 30 minutes at a temperature in a range of from about 120° C. to about 200° C.

Also provided is a method for treating a subterranean formation penetrated by a wellbore using a degradable material that includes stereocomplex polylactic acid. The method includes injecting into the wellbore a treatment fluid that has a pH in a range of from about 4.0 to about 9.0, and includes a carrier fluid, a proppant, and the degradable material. The degradable material is hydrolytically stable for at least 30 minutes at a temperature in a range of from about 120° C. to about 180° C.

### BRIEF DESCRIPTION OF THE DRAWINGS

Certain embodiments of the disclosure will hereafter be described with reference to the accompanying drawings. It should be understood, however, that the accompanying figures illustrate the various implementations described herein and are not meant to limit the scope of various technologies described herein.

FIG. 1 is a table comparing the ability of poly(L-lactic acid) fibers and stereocomplex polylactic acid fibers to prevent proppant settling.

FIG. 2 is a table comparing the ability of poly(L-lactic acid) fibers and stabilized stereocomplex polylactic acid fibers to prevent proppant settling.

FIG. 3 is a table comparing the hydrolytic stability of poly(L-lactic acid) fibers, stereocomplex polylactic acid fibers, and stabilized stereocomplex polylactic acid fibers.

### DETAILED DESCRIPTION OF EMBODIMENTS

At the outset, it should be noted that in the development of any such actual embodiment, numerous implementation-specific decisions may be made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure.

In addition, the composition used/disclosed herein can also comprise some components other than those cited. In the summary and this detailed description, each numerical value should be read once as modified by the term “about” (unless already expressly so modified), and then read again as not so modified unless otherwise indicated in context. Also, in the summary and this detailed description, it should be understood that a range listed or described as being useful, suitable, or the like, is intended to include support for any conceivable sub-range within the range at least because every point within the range, including the end points, is to be considered as having been stated. For example, “a range of from 1 to 10” is to be read as indicating each possible number along the continuum between about 1 and about 10. Furthermore, one or more of the data points in the present examples may be combined together, or may be combined with one of the data points in the specification to create a range, and thus include each possible value or number within this range. Thus, even if a specific data points within the range, or even no data points within the range, are explicitly identified or refer to a few specific, it is to be understood that inventors appreciate and understand that any conceivable data point within the range is to be considered to have been specified, and that inventors possessed knowledge of the entire range and each conceivable point and sub-range within the range.

The following definitions are provided in order to aid those skilled in the art in understanding the detailed description.

The term “treatment,” or “treating,” refers to any subterranean operation that uses a fluid in conjunction with a desired function and/or for a desired purpose. The term “treatment,” or “treating,” does not imply any particular action by the fluid.

The term “fracturing” refers to the process and methods of breaking down a subterranean formation (i.e., the rock formation around a well bore) and creating a fracture by pumping fluid at a very high pressure (a pressure above the determined closure pressure of the formation) in order to increase production rates from a hydrocarbon reservoir.

The term “zone of treatment” refers to the fractured area of the subterranean formation surrounding the wellbore.

As described herein, methods are provided for treating a subterranean formation penetrated by a wellbore. For example, the treatment may include hydraulic fracturing or acidizing of the subterranean formation. The methods include injecting a treatment fluid into the wellbore, and the treatment fluid may include a carrier fluid, a proppant, and a degradable material. The treatment fluid may have a pH of from 4.0 to 9.0, from 6.0 to 8.0, or from 6.5 to 7.5.

During treatment, the treatment fluid is injected into the wellbore in order to penetrate the fractures in the formation, delivering the proppant and degradable material into the fractures. The proppant and degradable material can then settle together in the fractures, preventing the fractures from sealing. The degradable material eventually degrades, leaving behind a porous proppant pack.

Depending on the function of the treatment fluid, the carrier fluid may include slickwater, spacer, mutual solvent, flush, formation dissolving fluid, fracturing fluid, scale dissolution fluid, paraffin dissolution fluid, asphaltene dissolution fluid, diverter fluid, water control agent, chelating agent, viscoelastic diverting acid, self-diverting acid, acid, or mixtures thereof.

Suitable proppant materials include sand, gravel, glass beads, ceramics, bauxites, glass, and combinations thereof. Plastic beads (e.g., styrene divinylbenzene) and particulate metals may also be used. The proppant may be composed of naturally occurring particular material, such as ground or crushed shells of nuts (e.g., walnut, coconut, pecan, almond, ivory nut, brazil nut, etc.); ground or crushed seed shells (including fruit pits) of seeds (e.g., seeds of plum, olive, peach, cherry, apricot, etc.); ground and crushed corn cobs or kernels; or processed wood materials (e.g., oak, hickory, walnut, poplar, mahogany).

The proppant may be selected based on its long-term strength, proppant distribution characteristics, and/or cost. The proppant should be strong enough to resist crushing under fracture closure stress. The average diameter of the proppant particles may be from 0.15 mm to 2.5 mm, from 0.25 mm to 1 mm, or from 0.5 mm to 0.75 mm. The proppant may be present in the treatment fluid in a concentration of from 0.1 kg/L to 1.0 kg/L, from 0.2 kg/L to 0.8 kg/L, or from 0.3 kg/L to 0.6 kg/L.

The degradable material may include the “stereocomplex” form of the aliphatic polyester of lactic acid, referred to as polylactic acid (also called “PLA,” “polylactate,” or “polylactide”). Lactic acid is a chiral molecule and has two optical isomers: D-lactic acid and L-lactic acid. The poly(L-lactic acid) and poly(D-lactic acid) forms are generally crystalline in nature. Polymerization of a mixture of the L- and D-lactic acids to poly(DL-lactic acid) results in a polymer that is more amorphous in nature. Amorphous regions are more susceptible to hydrolysis than crystalline regions. Factors such as lower molecular weight, less crystallinity, and greater surface area-to-mass ratio also may result in faster hydrolysis. Notably, hydrolysis is also accelerated by an increase in temperature.

The “stereocomplex” form of polylactic acid is a crystalline form that contains a mixture of a “high-L” resin (polylactic acid that contains predominantly L-chirality), and “high-D” resin (polylactic acid that contains predominantly D-chirality). The high-L resin contains at least 90%, 95%, or 98% D-chirality. Similarly, the high-D resin contains at least 90%, 95%, or 98% D-chirality. A weight ratio of the high-L and high-D resins in the mixture may be from 40:60 to 60:40 or from 45:55 to 55:45. For example, the ratio of enantiomers may be 50:50. The stereocomplex form may be obtained by mixing the high-D resin and high-L resin in solution or a molten state so that the resins are alternately arranged. For example, the resins may be blended together at a temperature of greater than or equal to 220° C. The stereocomplex form exhibits a crystalline melting temperature of from 40° C. higher to 60° C. higher than high-L resin or high-D resin by itself due to the crystalline structure formed by the alternating resins.

The stereocomplex polylactic acid is capable of undergoing an irreversible breakdown into fundamental acid products downhole. As referred to herein, the term “irreversible” will be understood to mean that the stereocomplex polylactic acid, once broken down downhole, will not reconstitute while downhole. That is, the polymer will break down in situ but will not reconstitute in situ. The term “break down” refers to both the two relatively extreme cases of hydrolytic degradation that the polymer may undergo, e.g., bulk erosion and surface erosion, and any stage of degradation in between these two. The rate at which polymeric break down takes place may depend on, for example, the temperature in the zone of treatment downhole.

The degree of polymerization of the linear stereocomplex polylactic acid can vary from a few units (2-10 units) (oligomers) to several thousand units (e.g. 2,000-5,000). The stereocomplex polylactic acid may have a number-average molecular weight of 50,000 g/mol or greater. For example, the stereocomplex polylactic acid may have a number-average molecular weight of from 80,000 g/mol to 300,000 g/mol, from 95,000 g/mol to 210,000 g/mol, or from 110,000 g/mol to 120,000 g/mol. The degradable material may contain the stereocomplex polylactic acid in an amount of from 85 wt % to 99.9 wt %, from 95 wt % to 99.8 wt %, or from 99 wt % to 99.7 wt %.

The degradable material may further include a crystallization nucleator, such as a phosphate metal salt, in an amount of from 0 wt % to 5 wt %, from 0.01 wt % to 1 wt %, or from 0.02 wt % to 0.5 wt %. The phosphate metal salt may have an average primary particle diameter of from 0.01 μm to 10 μm, or from 0.05 μm to 7 μm. The phosphate metal salt may be a compound represented by the following formula (1) or formula (2).

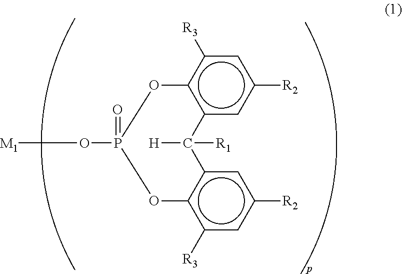

In the formula (1), R₁ is a hydrogen atom or alkyl group having 1 to 4 carbon atoms. Examples of the alkyl group having 1 to 4 carbon atoms represented by R₁ include a methyl group, ethyl group, n-propyl group, iso-propyl group, n-butyl group, sec-butyl group and iso-butyl group.

R₂ and R₃ are each independently a hydrogen atom or alkyl group having 1 to 12 carbon atoms. Examples of the alkyl group having 1 to 12 carbon atoms include a methyl group, ethyl group, n-propyl group, iso-propyl group, n-butyl group, sec-butyl group, iso-butyl group, tert-butyl group, amyl group, tert-amyl group, hexyl group, heptyl group, octyl group, iso-octyl group, tert-octyl group, 2-ethylhexyl group, nonyl group, iso-nonyl group, decyl group, iso-decyl group, tert-decyl group, undecyl group, dodecyl group and tert-dodecyl group.

M₁ is an alkali metal atom such as Na, K and Li, or an alkali earth metal atom such as Mg or Ca. p is 1 or 2.

For example, in the phosphate metal salt represented by formula (1), R₁ may be a hydrogen atom, and R₂ and R₃ may both be tert-butyl groups.

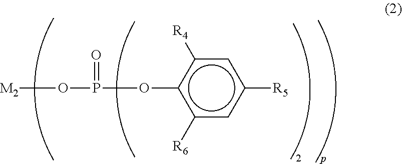

In the formula (2), R₄, R₅, and R₆ are each independently a hydrogen atom or alkyl group having 1 to 12 carbon atoms. Examples of the alkyl group having 1 to 12 carbon atoms include a methyl group, ethyl group, n-propyl group, iso-propyl group, n-butyl group, sec-butyl group, iso-butyl group, tert-butyl group, amyl group, tert-amyl group, hexyl group, heptyl group, octyl group, iso-octyl group, tert-octyl group, 2-ethylhexyl group, nonyl group, iso-nonyl group, decyl group, iso-decyl group, tert-decyl group, undecyl group, dodecyl group and tert-dodecyl group.

M₂ is an alkali metal atom such as Na, K or Li, or an alkali earth metal atom such as Mg or Ca. p is 1 or 2.

For example, in the phosphate metal salt represented by formula (2), R₄ and R₆ may both be methyl groups, and R₅ may be a tert-butyl group.

The degradable material may further comprise a stabilizer, such as a carbodiimide compound, in an amount of from 0.1 wt % to 15 wt %, from 0.2 wt % to 5 wt %, or from 0.3 wt % to 1 wt %. In some embodiments, upon heating of the polylactic acid to form the stereocomplex polylactic acid, the carbodiimide compound may react with the polylactic acid via the imide groups in the carbodiimide compound. The carbodiimide compound may be obtained by heating an organic diisocyanate in the presence of a carbodiimidation catalyst. Cyclic phosphine oxides, such as 3-methyl-1-phenyl-3-phosphorene-1-oxide, are suitable catalysts. The carbodiimide compound may be a cyclic carbodiimide compound. Additionally, a carbodiimide radical may be used. The carbodiimide compound may be selected to reduce the amount of isocyanate gas or other toxic products that could otherwise be produced during hydrolysis.

Suitable carbodiimide compounds include monocarbodiimide compounds and polycarbodiimide compounds such as dicyclohexyl carbodiimide, diisopropyl carbodiimide, diisobutyl carbodiimide, dioctyl carbodiimide, octyldecyl carbodiimide, di-tert-butyl carbodiimide, dibenzyl carbodiimide, diphenyl carbodiimide, N-octadecyl-N′-phenyl carbodiimide, N-benzyl-N′-phenyl carbodiimide, N-benzyl-N′-tolyl carbodiimide, di-o-toluoyl carbodiimide, di-p-toluoyl carbodiimide, bis(p-aminophenyl)carbodiimide, bis(p-chlorophenyl)carbodiimide, bis(o-chlorophenyl)carbodiimide, bis(o-ethylphenyl)carbodiimide, bis(p-ethylphenyl)carbodiimide, bis(o-isopropylphenyl)carbodiimide, bis(p-isopropylphenyl)carbodiimide, bis(o-isobutylphenyl)carbodiimide, bis(p-isobutylphenyl)carbodiimide, bis(2,5-dichlorophenyl)carbodiimide, bis(2,6-dimethylphenyl)carbodiimide, bis(2,6-diethylphenyl)carbodiimide, bis(2-ethyl-6-isopropylphenyl)carbodiimide, bis(2-butyl-6-isopropylphenyl)carbodiimide, bis(2,6-diisopropylphenyl)carbodiimide, bis(2,6-di-tert-butylphenyl)carbodiimide, bis(2,4,6-trimethylphenyl)carbodiimide, bis(2,4,6-triisopropylphenyl)carbodiimide, bis(2,4,6-tributylphenyl)carbodiimide, di-.beta.-naphthylcarbodiimide, N-tolyl-N-cyclohexylcarbodiimide, N-tolyl-N′-phenylcarbodiimide, p-phenylenebis(o-toluylcarbodiimide), p-phenylenebis(cyclohexylcarbodiimide, p-phenylenebis(p-chlorophenylcarbodiimide), 2,6,2′,6′-tetetraisopropyldiphenyl carbodiimide, hexamethylenebis(cyclohexylcarbodiimide), ethylenebis(phenylcarbodiimide) ethylenebis(cyclohexylcarbodiimide), and N-ethyl-N-(3-dimethylamino)propylcarbodiimide. However, any carbodiimide compound may be used as long as it protects the ester linkage in the polylactic acid from hydrolytic cleavage.

The stabilizer may have a number-average molecular weight of from 100 g/mol to 10,000 g/mol, from 300 g/mol to 5,000 g/mol, or from 500 g/mol to 3,000 g/mol.

The degradable material may be in the form of a fiber. The fiber may have a length of from 1 mm to 30 mm, from 2 mm to 25 mm, or from 3 mm to 18 mm. Additionally, the fiber may have a diameter of from 5 μm to 200 μm or from 10 μm to 100 μm, and a denier of from 0.1 g/9,000 m to 20 g/9,000 m, or from 0.15 g/9,000 m to 6 g/9,000 m. The fiber may have a straight or crimped shape, and an aspect ratio of from 75 to 4,000, from 100 to 1,000, or from 300 to 600.

The degradable material may be coated with a hydrophobic layer. Suitable coating materials include polycaprolate (a copolymer of glycolide and epsilon-caprolactone), and calcium stearate. The degradable material may be coated via encapsulation or by chemical reaction with the surface of the degradable material.

The degradable material may be present in the treatment fluid at a concentration of from 0.1 g/L to 10 g/L, from 1.5 g/L to 7.5 g/L, or from 3 g/L to 6 g/L.

The degradable material is hydrolytically stable for at least 30 minutes at a temperature of from 120° C. to 200° C., from 130° C. to 195° C., from 140° C. to 190° C., from 150° C. to 185° C., or from 160° C. to 180° C. Thus, the method for treating a subterranean formation may be performed where a temperature in the zone of treatment is from 40° C. to 200° C., such as from 150° C. to 185° C., or from 160° C. to 170° C. (that is, at “high temperatures”).

The term “hydrolytic stability” refers to the material's ability to resist hydrolysis. A material is considered “hydrolytically stable” if it does not undergo hydrolysis, or undergoes hydrolysis to a degree that does not affect the material's ability to prevent proppant settling when delivered together with proppant. If no change is seen in the material's ability to prevent proppant settling after being heated at a particular temperature for at least 30 minutes, the material is considered to be hydrolytically stable for at least 30 minutes at that temperature.

Additional viscosifiers may be added to the treatment fluid to further increase the viscosity. Such viscosifiers include viscoelastic surfactants; guar gums; high molecular weight polysaccharides composed of mannose and galactose sugars; and guar derivatives, such as hydroxypropyl guar, carboxymethyl guar, and carboxymethylhydroxypropyl guar. The additional viscosifier may be included in the carrier fluid at a concentration of from 0.1 g/L to 10 g/L, from 1.5 g/L to 7.5 g/L, or from 3 g/L to 6 g/L. The resulting treatment fluid may have a viscosity of 50 cP or greater, 75 cP or greater, or 100 cP or greater.

### EXAMPLES

It should be recognized that the examples below are provided to aid in an understanding of the present teachings. The examples should not be construed so as to limit the scope and application of such teaching to the content of the examples.

It is noted that BIOFRONT J20 (Teijin Ltd.) and BIOFRONT J201 (Teijin Ltd.) were used as the degradable materials in the examples and the experiments. However, the selection of these degradable materials is provided to facilitate description, and the present description's focus on such use should not be deemed limiting of the proposed concepts and teachings.

A degradable material was considered to be adequate for treating a subterranean wellbore where the material remained hydrolytically stable at elevated downhole temperatures and yet retained effective proppant settling control.

Proppant Settling

A treatment fluid was prepared based on linear guar gel. Specifically, the treatment fluid included 5.4 g/L guar gum and 480 g/L ceramic proppant 12/18 U.S. Standard Mesh size (1.0 mm-1.7 mm, 1.4 mm mean diameter). A control treatment fluid was prepared containing no degradable material, and three trial treatment fluids were prepared containing 4.8 g/L fiber (degradable material). Proppant settling was calculated as:

Proppant settling (%)=V_{0%}−V_{T}_{ₙ}/V_{0%}−V_{100%}×100%

In the above formula, V_{0%} represents the initial volume of proppant at time 0 min, V_{T}_{ₙ} represents the volume occupied by settled proppant at time Tₙ, and V_{100%} represents the volume occupied by the proppant at 100% settling. The objective was to reduce the amount of proppant that settled.

For these experiments, three fibers were studied. As examples within the disclosed embodiments, BIOFRONT J20 and BIOFRONT J201 crimped fibers were used. BIOFRONT J20 fibers are formed of stereocomplex polylactic acid, and BIOFRONT J201 fibers are formed of stereocomplex polylactic acid stabilized with a carbodiimide compound. The compositions of the BIOFRONT fibers are proprietary of Teijin Ltd. The fibers had a diameter of 12 μm and a length of 6 mm.

As a comparative example, INGEO 6202D uncrimped (straight) fibers (Nature Works LLC) were studied. The INGEO 6202D fibers are formed of poly(L-lactic acid). The composition of the INGEO 6202D fibers is proprietary of NatureWorks LLC. The fibers had a diameter of 12 μm and a length of 6 mm.

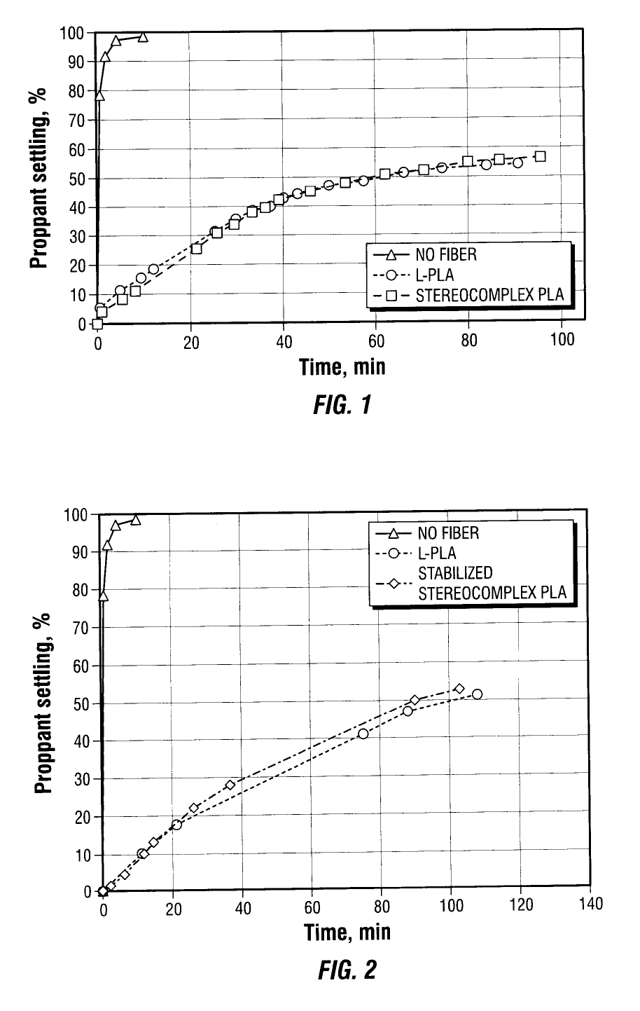

As shown in FIGS. 1 and 2, the stereocomplex polylactic acid and stabilized stereocomplex polylactic acid fibers both achieved the same level of proppant settling control as the poly(L-lactic acid) fibers. That is, the stereocomplex polylactic acid and stabilized stereocomplex polylactic acid fibers prevented the proppant from settling to the same degree as the poly(L-lactic acid) fibers. The delivery of fibers together with the proppant improved proppant settling as compared to delivery of proppant without fibers.

Hydrolytic Stability

For these experiments, 1 g of fiber material was mixed with 100 mL deionized water and placed into a stainless steel reactor under a nitrogen atmosphere at a pressure of 200 psi to 300 psi. The treatment fluid was heated over 15 minutes and a constant rate of temperature increase until the target temperature was reached. The treatment fluid was held at this temperature for a period of time ranging from 10 minutes to 240 minutes, (depending on exposure temperature), and then cooled to room temperature over a period of 5 minutes. The fiber material was then removed from the reactor, filtered through a 20 μm filter, dried, and weighed to determine mass loss.

For each temperature tested, it was determined how long the fiber could be heated at the tested temperature while retaining its ability to prevent proppant settling. When the fiber could no longer provide the same degree of proppant settling reduction compared to an unheated state, the fiber was considered hydrolytically unstable.

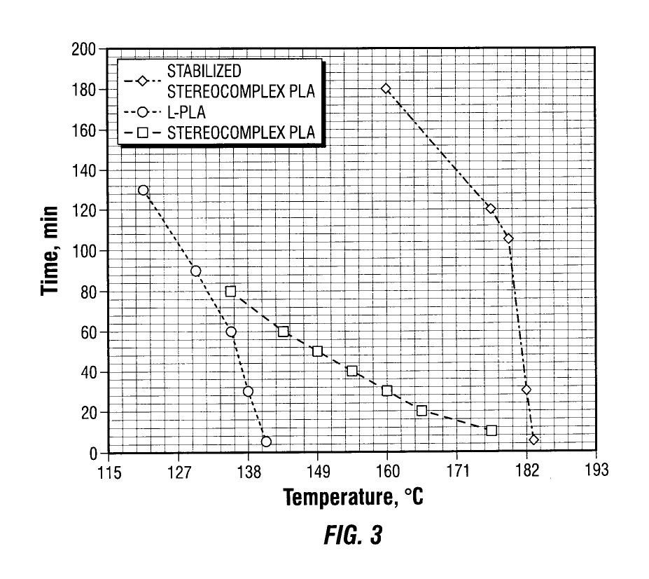

The results of hydrolytic stability are summarized in FIG. 3 for each temperature tested. In FIG. 3, the area above each line corresponds to the conditions in which the fibers become hydrolytically unstable, and the area below the line and the line itself corresponds to the conditions in which the fibers retain proppant settling performance after heat exposure (i.e., the conditions in which the fibers remain hydrolytically stable).

As shown in FIG. 3, the stereocomplex polylactic acid fibers had noticeably higher hydrolytic stability than the poly(L-lactic acid) fibers. In particular, the stereocomplex polylactic acid fibers remained hydrolytically stable for up to 30 minutes at a temperature of 320° F. (160° C.), while the poly(L-lactic acid) fibers remained hydrolytically stable for 30 minutes at a temperature of just 280° F. (138° C.) or lower.

Furthermore, the stabilized stereocomplex polylactic acid fibers had noticeably greater hydrolytic stability than the poly(L-lactic acid) fibers and even the non-stabilized stereocomplex polylactic acid fibers. In particular, the stabilized stereocomplex polylactic acid fibers remained hydrolytically stable for up to 30 minutes at a temperature of 360° F. (182° C.). At 320° F. (160° C.), the stabilized fibers were hydrolytically stable for 180 minutes. Accordingly, the stabilized stereocomplex polylactic acid fibers provided enhanced proppant transport even at high temperatures.

Although only a few example embodiments have been described in detail above, those skilled in the art will readily appreciate that many modifications are possible in the example embodiments without materially departing from the disclosed METHODS FOR TREATING HIGH TEMPERATURE SUBTERRANEAN FORMATIONS. Accordingly, all such modifications are intended to be included within the scope of this disclosure as defined in the following claims.

Although the preceding description has been described herein with reference to particular means, materials and embodiments, it is not intended to be limited to the particulars disclosed herein; rather, it extends to all functionally equivalent structures, methods and uses, such as are within the scope of the appended claims.

In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112(f) for any limitations of any of the claims herein, except for those in which the claim expressly uses the words “means for” together with an associated function.

What is claimed is:

1. A method for treating a subterranean formation penetrated by a wellbore, the method comprising:
injecting a treatment fluid into the wellbore, wherein:
the treatment fluid comprises a carrier fluid, a proppant, and a degradable material comprising stereocomplex polylactic acid stabilized with a carbodiimide compound, the treatment fluid having a pH in a range of from about 4.0 to about 9.0, and
the degradable material is hydrolytically stable for at least 30 minutes at a temperature in a range of from about 120° C. to about 200° C.

2. A method as in claim 1, wherein the carbodiimide compound has a number-average molecular weight in a range of from about 100 g/mol to about 10,000 g/mol.

3. A method as in claim 1 or claim 2, wherein the carbodiimide compound is a cyclic carbodiimide compound.

4. A method as in claim 1 or claim 2, wherein the carbodiimide compound is selected from the group consisting of monocarbodiimide compounds and polycarbodiimide compounds such as dicyclohexyl carbodiimide, diisopropyl carbodiimide, diisobutyl carbodiimide, dioctyl carbodiimide, octyldecyl carbodiimide, di-tert-butyl carbodiimide, dibenzyl carbodiimide, diphenyl carbodiimide, N-octadecyl-N-phenyl carbodiimide, N-benzyl-N′-phenyl carbodiimide, N-benzyl-N′-tolyl carbodiimide, di-o-toluoyl carbodiimide, di-p-toluoyl carbodiimide, bis(p-aminophenyl)carbodiimide, bis(p-chlorophenyl)carbodiimide, bis(o-chlorophenyl)carbodiimide, bis(o-ethylphenyl)carbodiimide, bis(p-ethylphenyl)carbodiimide, bis(o-isopropylphenyl)carbodiimide, bis(p-isopropylphenyl)carbodiimide, bis(o-isobutylphenyl)carbodiimide, bis(p-isobutylphenyl)carbodiimide, bis(2,5-dichlorophenyl)carbodiimide, bis(2,6-dimethylphenyl)carbodiimide, bis(2,6-diethylphenyl)carbodiimide, bis(2-ethyl-6-isopropylphenyl)carbodiimide, bis(2-butyl-6-isopropylphenyl)carbodiimide, bis(2,6-diisopropylphenyl)carbodiimide, bis(2,6-di-tert-butylphenyl)carbodiimide, bis(2,4,6-trimethylphenyl)carbodiimide, bis(2,4,6-triisopropylphenyl)carbodiimide, bis(2,4,6-tributylphenyl)carbodiimide, di-.beta.-naphthylcarbodiimide, N-tolyl-N′-cyclohexylcarbodiimide, N-tolyl-N′-phenylcarbodiimide, p-phenylenebis(o-toluylcarbodiimide), p-phenylenebis(cyclohexylcarbodiimide, p-phenylenebis(p-chlorophenylcarbodiimide), 2,6,2′,6′-tetetraisopropyldiphenyl carbodiimide, hexamethylenebis(cyclohexylcarbodiimide), ethylenebis(phenylcarbodiimide) ethylenebis(cyclohexylcarbodiimide), and N-ethyl-N-(3-dimethylamino)propylcarbodiimide.

5. A method as in any one of the preceding claims, wherein a temperature in a zone of treatment of the subterranean formation is in a range of from about 40° C. to about 200° C., and in particular is in a range of from about 150° C. to about 185° C.

6. A method as in any one of the preceding claims, wherein the stereocomplex polylactic acid contains L-isomers and D-isomers in a ratio in a range of from about 60:40 to about 40:60, and in particular in a ratio of about 50:50.

7. A method as in any one of the preceding claims, wherein the degradable material is in the form of a fiber.

8. A method as in claim 7, wherein the fiber has an aspect ratio in a range of from about 75 to about 4,000, and in particular in a range of from about 300 to about 600.

9. A method as in claim 7, wherein the fiber has a straight shape or a crimped shape.

10. A method as in any one of the preceding claims, wherein an amount of the stereocomplex polylactic acid in the degradable material is in a range of from about 85 wt % to about 99.9 wt %, and an amount of the carbodiimide compound in the degradable material is in a range of from about 0.1 wt % to about 15 wt %.

11. A method as in any one of the preceding claims, wherein the stereocomplex polylactic acid has a number-average molecular weight of about 50,000 g/mol or greater.

12. A method as in any one of the preceding claims, wherein the stereocomplex polylactic acid has a number-average molecular weight in a range of from about 110,000 g/mol to about 120,000 g/mol.

13. A method as in any one of the preceding claims, wherein the treatment fluid has a pH in a range of from about 6.0 to about 8.0.

14. A method as in any one of the preceding claims, wherein the treatment of the subterranean formation is hydraulic fracturing or acidizing.

15. A method for treating a subterranean formation penetrated by a wellbore, the method comprising:
injecting a treatment fluid into the wellbore, wherein:
the treatment fluid comprises a carrier fluid, a proppant, and a degradable material comprising stereocomplex polylactic acid, the treatment fluid having a pH in a range of from about 4.0 to about 9.0, and
the degradable material is hydrolytically stable for at least 30 minutes at a temperature in a range of from about 120° C. to about 180° C.
